(19) United States
(12) Patent Application Publication
(10) Pub. No.: US 2010/0038496 A1
(43) Pub. Date: Feb. 18, 2010

(54) CABLE LADDER DEVICE

(76) Inventor: Dan Sjoqvist, Anderstorp (SE)

Correspondence Address: DICKSTEIN SHAPIRO LLP, 1825 EYE STREET NW, Washington, DC, 20006-5403, US

(21) Appl. No.: 12/530,149

(22) PCT Filed: Feb. 15, 2008
(86) PCT No.: PCT/SE08/00123

§ 371 Date: Sep. 10, 2009

(30) Foreign Application Priority Data
Mar. 14, 2007 (SE) 0700630-7

(51) Int. Cl. F16L 3/12; F16L 3/08

(52) U.S. Cl. 248/73

(57) ABSTRACT

A cable support device (6) for the fixation onto a cable ladder (1), which is U-shaped as seen in a transversal section with two sides and a bottom, includes a support portion (7) for supporting cables (5) leading to and from the cable ladder and being shaped so as to ensure that a radius of curvature of these cables on the support portion is not lower than a certain value, and fastening means (8,8′) for fastening to a cable ladder, is distinguished in that said fastening means exhibits engagement means (9,9′) for engagement with longitudinal thread elements extending on the side of the cable ladder, and holding means (10) for the co-operation with a holding portion (11) which is arranged on the support portion, and guiding means (12,12′) for guiding cables leading to and from for lying against the support portion.

### FIELD OF THE INVENTION

The invention concerns cable support devices according to the preamble of claim 1 as well as the preamble of claim 13.

### BACKGROUND OF THE INVENTION

Cable ladders for collected reception of different types of cables which are on the one hand containing electrically conducting and on the other hand light conducting elements are previously known. The cable ladders are typically supported by brackets that are attached onto surfaces in buildings and are comprised of lattice-work constructions formed from a plurality of longitudinal rigid thread elements that are interconnected by transversally extending thread elements. When the cable ladders have been provided with a U-shaped transversal section, a chute-form is created for effective positioning of the cables.

Different devices are previously known in order to join, lead off and bifurcate cable ladder elements for the formation of integrated systems for positioning of cables in buildings.

In cable ladders and also in respect of otherwise positioned cables, and in particular in a branching point for cables led to and from the cable ladders, there are requirements that the cables are given a radius of curvature which does not go below a certain value. This is necessary particularly in respect of cables containing optic fibres, since the integrity of the optic fibres can be jeopardised if they are given too abrupt bends. Also for other kinds of cables there are requirements that a cable bend is not too abrupt.

From U.S. Pat. No. 6,024,329 is previously known a device which is distinguished by being connectable to a cable ladder in order to form a support surface for cables extending along the cable ladder and are branched off downwardly therefrom in order to control the radius of curvature of the branched off cables.

This device functions well but is limiting the possibilities of arranging lead-offs from the cable ladder in a desired manner.

### AIM AND MOST IMPORTANT FEATURE OF THE INVENTION

It is an aim of the invention to provide a device according to the above wherein the limitations of the background art are avoided and wherein the freedom for drawing cables is increased. These aims are achieved through the invention in a device according to the above which is characterized by the features of the characterizing portion of claim 1. Hereby is allow that cables can be branched-off sideways from the cable ladder over the sideward thread elements of the cable ladder and thereafter be drawn in a suitable direction, for example in the direction downwardly or sidewardly by maintaining the requirements for the respective cables not to be exerted for a too abrupt bend.

The guiding means provides for the cables to be guided for lying against the support portion whereby sliding along the free upper edge of the cable ladder can be avoided.

Hereby the advantage is obtained that branched-off cables can be handled more easily than is the case in a device according to the above mentioned patent document, since it will become more simple for an operator to handle the cables in the cable ladder, when those that are subject to be branched-off do not have to be positioned at the bottom of the cable ladder but instead be at the upper side of the cable ladder. This is an advantage when the cable ladder contains a great number of cables positioned on top of each other.

Further it is advantageous in many applications that the branched-off cables are positioned on one side of the cable ladder, whereby it will be more easy to arrange for the further drawing of the branched-off cables, along a wall, into another cable ladder or in any other support arrangement. Further advantages are that a cable support device according to the invention can be simply mounted to a cable ladder after the cables having been positioned inside the cable ladder. This is otherwise very difficult to achieve in respect of a device according to the background art if the cable ladder contains a greater number of often rigid cables that are difficult to handle. A cable support device according to the invention will further not take up any space inside the cable ladder, which would otherwise interfere with the cable space.

The guiding means are suitably designed to continue in a direction of the “Shank” of the U-shape and in particular the guiding means and the fastening means are integral parts of the same element. The holder portion of the support portion suitably includes recesses such as holes for the holding means of the fastening means and the support portion is hereby supported without the support portion having to be permanently fixed to the cable ladder.

It is preferred that the support portion is constructed such that in use it extends with a curved region outside said surface, whereby said curved region particularly forms a part of a cylinder which has the cylinder axis essentially in parallel with the longitudinal direction of the cable ladder.

Preferably the support portion includes a hook means for positioning inside the thread element on said side, in particularly such that the support portion is positioned such that it abuts the outermost thread element of the “shank” and the hook means is positioned on the inside of this thread element.

It is preferred that the integrated fastening means/guiding means has a tubular shape, such at this tubular element is gentle to the cables.

In particular the cable support device includes two such elements, wherein between the guiding means, there is arranged a space for cables led to and from, such that branching-off can be had of cables which come from both sides of a position where a cable support device is situated. The use of two elements also results in greater stability of the device.

Preferably the support portion is made from a metal plate which has been provided with a curvature of suitable magnitude, whereas the element comprising the fastening means/guiding means is comprised of a metal tube.

In another aspect of the invention there is provided a cable support device which has the aim, when required, to be attached to the U-shanks of a cable ladder in order to increase the side height. Hereby said fastening means exhibit engagement means for engagement with longitudinal thread elements extending at a side of the cable ladder. The cable support device includes support devices for guiding cables for lying inside the cable ladder, whereby said guiding means is shaped such that in use it extends essentially in a direction continuous of the direction of said side, and wherein said guiding means is an integral part of said fastening means. Hereby is achieved a simple and effective support device for cables, in particular if unexpectedly many cables have to be positioned in a cable ladder. The locking of the device onto the thread elements can be made in many ways such as with a locking pin (see FIG. 3) or with other means which is indicated below.

Further features and advantages of the invention will come clear from the following detail description.

### BRIEF DESCRIPTION OF DRAWINGS

The invention will no be described in greater detail by way of embodiments and with reference to the drawings, wherein:

FIG. 1 in a diagrammatical overview shows a cable ladder with attached cable support device and positioned cables,

FIG. 2 shows diagrammatically a side view of a cable support device,

FIG. 3 shows diagrammatically a locking pin for the use in the cable support device, and

FIG. 4 shows a support portion for a cable support device in a perspective view.

### DESCRIPTION OF EMBODIMENT

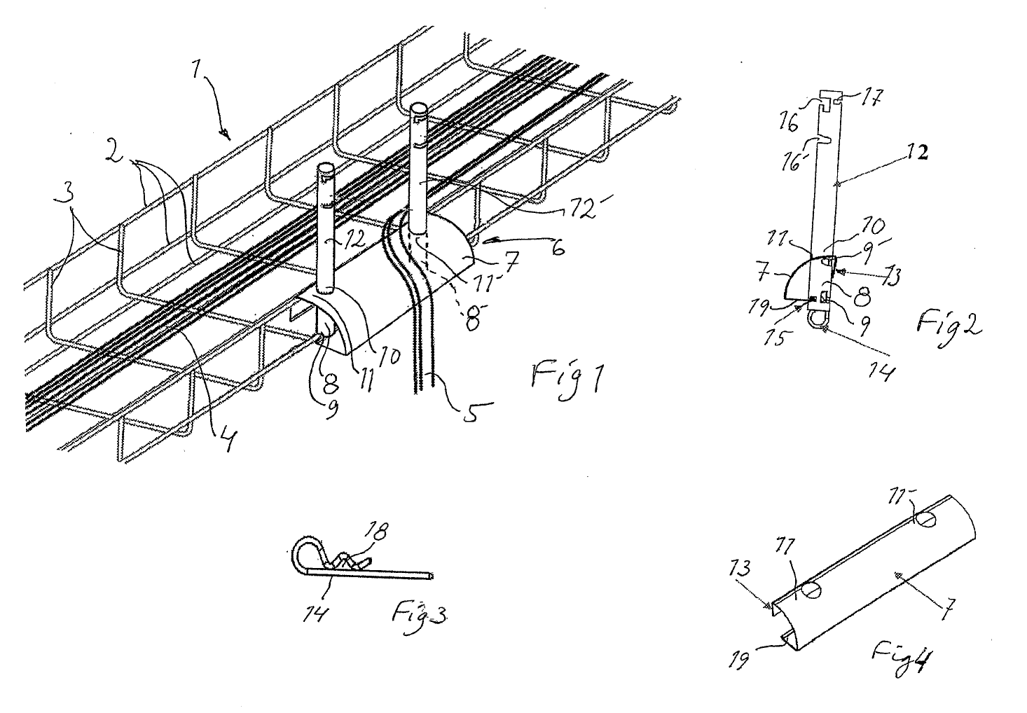

In FIG. 1 numeral 1 in general indicates a cable ladder being comprised of a number of longitudinal thread elements 2, which are fixed by means of a plurality of transversal thread elements 3 for forming a U-shape with two sides and a bottom. Such cable ladders are per se previously known and are arranged to carry different types of cables 4.

In order to securely branch-off cables 5 to and from, there is arranged a cable support device 6, which includes a support portion 7 being comprised of a unit with a construction extending sideways from the cable ladder, which has been provided with a curvature in order to avoid too abrupt bending of the cables 5. The support portion 7 is fastened to the cable ladder by means of fastening means 8, 8′, which in the shown example are comprised of tubes having engagements means 9 for the co-operation with two thread elements on the one side of the cable ladder.

The fastening means also comprise holding means 10 which extend outside the U-shape of the cable ladder and co-operate with holding portions 11, 11′ of the support portion 7, said holding portions providing holes adapted to allow the passage of the said holding means 10. Further, in the shown example, each fastening means 8 with holding means 10 is a metal tube, which is also an integral element with a guiding means 12 (12′) which has the purpose to prevent cables being branched-off from the cable support device 6 from sliding off from the support portion 7. Instead, these cables 5 will be positioned in the space between two guiding means 12, 12′.

In FIG. 2, the cable support device 6 is shown seen from the side with the engagement means 9 and 9′ shown more clearly. The lower engagement means 9 is comprised of a first slot with L-shaped construction, as seen from the side, such that the fastening means 8 can be brought such that a thread element enters into the slot, whereupon the fastening means 8 is pressed somewhat downwardly so that the thread element will be positioned in the inner upper part of the slot. The fastening means 8 can thereafter be displaced angularly with its upper part inwardly, such that also an upper engagement means 9′, which is a straight slot, engages with a thread element, namely, the upper thread element at the side of the cable ladder. Thereupon a locking pin 14 can be brought in through a lower opening of the tubular fastening means 8 such that exit of said thread elements from the slots/engagement means 9, 9′ is prevented.

The support portion 7 includes holding portions 11 (11′) for the co-operation with the fastening means, and in particular its holding means 10.

The support portion 7 is attached, in use, simply by being slid downwardly against the cable ladder over two fastening means 8, 8′, being applied to the cable ladder, whereby an angular bend, being comprised by a hook means 13, will be positioned inside an upper thread elements on an inside of the cable ladder.

At its lower part, the support portion 7 exhibits an inward bend 19 in the direction against the fastening means 8, which inward bend is in the form of a stabilizing portion 19, which is ended by a bend, which in turn is adapted to fit into a recess 15 in the fastening means 8. The recess 15 provides a locking knob for the co-operation with said bend and thereby snap-locking of the stabilizing portion 19 of the support portion 7.

At its second or upper end region, which in the shown embodiment is comprised by the end of the guiding means 12, the integral tube-shaped element provides an engagement means 16, 16′, which has the corresponding shape as the engagement means 9, 9′, but which is designed with other dimensions in order to fit onto cable ladders with thicker (or possibly thinner) thread elements. The recess 17 corresponds to the recess 15, and in this position there is also more clearly shown an upper directed locking knob for the co-operation with a bend of a stabilizing portion.

FIG. 3 shows in detail the locking pin 14, and with 18 is indicated a recess for the co-operation with a thread element of the cable ladder, corresponding to the position of the slot/engagement means 9 in FIG. 2.

The outermost, on the figure the right, part of the locking pin 14, comprises the locking part at the engagement means 9′ in FIG. 2.

In FIG. 4 is shown the support portion 7 with its stabilizing portion 19 with an outermost bend, the hook means 13 and the holding portions 11, 11′.

The invention can be modified within the scope of the following claims. It is thus possible to envisage an embodiment wherein only one fastening means being integral with the guiding means is being used. It is possible to envisage that the fastening means and the guiding means are separated self-standing units, even if this is not preferred. The support portion can be designed otherwise, and in particular the element corresponding to the hook means 13, can be arranged to contact directly against the upper longitudinal thread element of the cable ladder. The design with the bend can be made differently and the radius of curvature can be adapted to the situation at hand and the requirements for the respective positioned cables.

Normally, the fastening means and thereby the cable support device can be secured in its fastening without any locking pin having to be used for securing the attachment, for example by snap-action with the thread elements of the cable ladder. In the embodiment shown in the figures, in practice locking is achieved by the unit by locking co-operation of a hook means of the support portion with the inside of thread elements of the cable ladder.

The integrated tubular unit, which is more clearly shown in FIG. 2 and which includes the fastening means 8 and the guiding means 12, can be used separately by itself for increasing the side height of cable ladders in case the depth thereof should be insufficient. In that case locking is required through other means than by a support portion. Beside a locking pin 14, the design of the slots 9 and 9′ can be made such as to provide a safe locking effect.

1. Cable support device (6) for the fixation onto a cable ladder (1), which is essentially U-shaped as seen in a transversal section with two sides and a bottom, and is formed from a plurality of longitudinal rigid thread elements (2) extending at a distance from each other and a plurality of transversal rigid thread elements (3) for the interconnection thereof, wherein the cable support device includes a support portion (7) for supporting cables (5) leading to and from the cable ladder and being shaped so as to ensure that a radius of curvature of these cables on the support portion is not lower than a certain value, and
wherein the cable support device includes fastening means (8,8′) for fastening to a cable ladder, characterized in
that said fastening means exhibits engagement means (9,9′) for engagement with longitudinal thread elements extending on the side of the cable ladder, and holding means (10) for the co-operation with a holding portion (11) which is arranged on the support portion, and
that the cable support device includes guiding means (12,12′) for guiding cables leading to and from for lying against the support portion.

2. Device according to claim 1, characterized in that said guiding means (12,12′) is arranged, in use, to extend essentially in the continued direction of said side.

3. Device according to claim 1, characterized in said control means is an integral part of said fastening means.

4. Device according to claim 1, characterized in that the holding portion includes a recess for said holding means.

5. Device according to claim 1, characterized in that the support portion (7) is constructed such that it in use extends with a curved region outside said side.

6. Device according to claim 5, characterized in that the support portion (7) includes a hook means (13) for the positioning inside thread element (2) on said side.

7. Device according to claim 1, characterized in that said fastening means in an end portion at a distance from the holding portion exhibits a recess for the co-operation with the support portion.

8. Device according to claim 1, characterized in that said fastening means and guiding means have tubular shape.

9. Device according to claim 8, characterized in that said engagement means in comprised of slot-shaped recesses for the co-operation with thread element (2).

10. Device according to claim 1, characterized in that it includes two fastening means and guiding means respectively, wherein between the guiding means is arranged a space for cables (5) leading to and from.

11. Device according to claim 1, characterized in that the fastening means and the guiding means are made from metal.

12. Device according to claim 1, characterized in that the support portion (7) is made from metal plate material.

13. Cable support device (6) for the fixation to a cable ladder (1) having essentially U-shape, as seen in a transversal section, with two sides and a bottom, and which is formed by a plurality of longitudinal rigid thread elements (2) extending at an distance from each other and a plurality of transversal rigid thread elements (3) for the interconnection thereof,
wherein the cable support device includes fastening means (8,8′) for fastening to the cable ladder, characterized in
that said fastening means exhibits engagement means (9,9′) for the engagement with longitudinal thread elements extending at one side of the cable ladder,
that the cable support device includes guiding means (12,12′) in order to guide cables for lying in the cable ladder,
that said guiding means (12,12′) is arranged for in use extend essentially in the continued direction of said side, and
that said guiding means is an integral part of said fastening means.

14. Device according to claim 13, characterized in that said fastening means and guiding means have tubular shape.

15. Device according to claim 13, characterized in that said engagement means are comprised of slot shaped recesses for the co-operation with thread elements (2).

16. Device according to claim 13, characterized in that it is made of metal.
